(19) United States
(12) Patent Application Publication
(10) Pub. No.: US 2023/0394698 A1
(43) Pub. Date: Dec. 7, 2023

(54) INFORMATION PROCESSING APPARATUS, NON-TRANSITORY COMPUTER READABLE MEDIUM, AND INFORMATION PROCESSING METHOD

(71) Applicant: FUJIFILM Business Innovation Corp., Tokyo (JP)

(72) Inventors: Ken SATO, Kanagawa (JP); Momoko FUJIWARA, Tokyo (JP); Masaki KYOJIMA, Kanagawa (JP)

(73) Assignee: FUJIFILM Business Innovation Corp., Tokyo (JP)

(21) Appl. No.: 17/984,788

(22) Filed: Nov. 10, 2022

(30) Foreign Application Priority Data
Jun. 7, 2022 (JP) 2022-092089

(51) Int. Cl. G06T 7/70; G06T 7/30

(52) U.S. Cl. CPC G06T 7/70; G06T 7/30

(57) ABSTRACT

An information processing apparatus includes a processor configured to: perform a first function of assisting a user to perform a first operation of multiple operations on an image capturing device such that posture of the image capturing device that captures an image of an object with respect to the object is maintained in specific posture; and perform a second function of assisting in performing a second operation of the multiple operations subsequent to the first operation in a case where the first operation ends.

### CROSS-REFERENCE TO RELATED APPLICATIONS

This application is based on and claims priority under 35 USC 119 from Japanese Patent Application No. 2022-092089 filed Jun. 7, 2022.

### BACKGROUND

### (i) Technical Field

The disclosure relates to an information processing apparatus, a non-transitory computer readable medium, and an information processing method.

### (ii) Related Art

Japanese Patent No. 6156586 discloses an identification device that displays an observation object shape image indicating a shape of an anti-counterfeit medium observed at an observation angle on a display screen, calculates a shape similarity between the observation object shape image and an outer shape of the anti-counterfeit medium serving as an imaging object on the display screen, and determines whether or not the observation angle and an observation position of the image capturing device are correct based on whether or not the shape similarity is equal to or greater than a shape similarity threshold.

### SUMMARY

In some cases where the image of an object is captured by an image capturing device, an operation of causing the posture of the image capturing device with respect to the object to match specific posture is performed. For example, it is thought that a guide for assisting a user to perform a first operation on the image capturing device such that a positional relationship between the object and the image capturing device is maintained in a specific positional relationship and a guide for assisting the user to perform a second operation on the image capturing device such that an angle between the object and the image capturing device is maintained at a specific angle are simultaneously outputted. For example, it is thought that a guide is displayed, a guide is outputted by using a voice, and a guide is displayed by using a character string. Specifically, it is thought that the guide for assisting in performing the first operation and the guide for assisting in performing the second operation are simultaneously displayed. In this case, it is difficult for the user to simultaneously perform the first operation and the second operation to cause the posture of the image capturing device with respect to the object to match the specific posture.

Aspects of non-limiting embodiments of the present disclosure relate to assistance for a user to readily maintain the posture of an image capturing device with respect to an object in specific posture unlike the case where a function of assisting the user to operate the image capturing device such that a positional relationship between the object and the image capturing device is maintained in a specific positional relationship and a function of assisting the user to operate the image capturing device such that an angle between the object and the image capturing device is maintained at a specific angle are simultaneously performed.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: perform a first function of assisting a user to perform a first operation of multiple operations on an image capturing device such that posture of the image capturing device that captures an image of an object with respect to the object is maintained in specific posture; and perform a second function of assisting in performing a second operation of the multiple operations subsequent to the first operation in a case where the first operation ends.

### BRIEF DESCRIPTION OF THE DRAWINGS

An exemplary embodiment of the present disclosure will be described in detail based on the following figures, wherein:

FIG. 1 illustrates the structure of an individual identification system according to an exemplary embodiment;

FIG. 2 illustrates a collation region viewed from a registration image capturing device;

FIG. 3 illustrates a collation region viewed from a collation image capturing device;

FIG. 4 is a block diagram illustrating the structure of the collation image capturing device;

FIG. 5 illustrates the collation image capturing device and an object in a three-dimensional space;

FIG. 6 illustrates the collation image capturing device and the object in the three-dimensional space;

FIG. 7 is a block diagram illustrating the structure of a collation device;

FIG. 8 illustrates a specific example of a guide A;

FIG. 9 illustrates specific examples of the guide A and a guide B;

FIG. 10 illustrates specific examples of the guide A and the guide B;

FIG. 11 is a diagram for describing the flow of processing in a first example;

FIG. 12 is a diagram for describing the flow of processing in a second example;

FIG. 13 illustrates a direction in which light is radiated to the object when a registration image is acquired;

FIG. 14 illustrates registration images and a collation image;

FIG. 15 illustrates collation images; and

FIG. 16 illustrates the collation images.

### DETAILED DESCRIPTION

A technique described below is used to maintain the posture of an image capturing device with respect to an object in specific posture in the case where the image capturing device captures an image of the object.

In the following description by way of example, an individual identification system is taken as an example. An exemplary embodiment, however, is not limited to the individual identification system. The exemplary embodiment may be used provided that the posture of the image capturing device with respect to the object is maintained in the specific posture.

The individual identification system uniquely identifies the object by collating a registration image and a collation image. The registration image is acquired in a manner in which the image of the object is captured in advance. The collation image is acquired to be collated together with the registration image in a manner in which the image of the object is captured.

For example, an image of a part or the whole of the surface of the object is registered in advance as inherent information about the object. The individual identification system uniquely identifies that the object to be collated is the same as a registered object, that is, the object to be collated is genuine.

An example of the inherent information about the object is a random pattern including a fine pattern. Specific examples of the random pattern include a frosted glass pattern, a pattern that is formed by processing metal or synthetic resin (for example, plastic), a wrinkled pattern that is acquired by texturing processing, a randomly braided pattern, a randomly and finely dotted pattern, a pattern (for example, a pattern that has random particle distribution) that is formed by printing with ink containing luminescent particles, and a hologram. The random pattern may be a pattern that is coincidentally formed without intensity or may be a pattern that is intentionally formed for collation. A technique of optically reading the random pattern to use this as information is an example of artifact metrics.

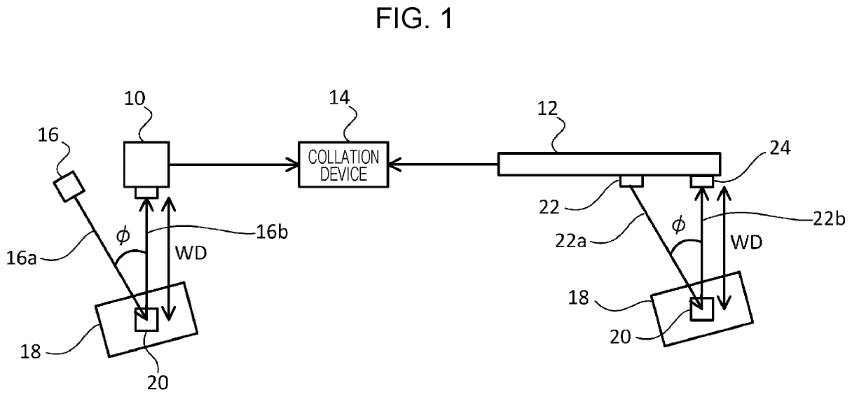

FIG. 1 illustrates the structure of the individual identification system according to the exemplary embodiment. The individual identification system is an example of an information processing system according to the exemplary embodiment.

The individual identification system according to the exemplary embodiment includes a registration image capturing device 10, a collation image capturing device 12, and a collation device 14. The registration image capturing device 10 is a device (for example, an exclusive camera for registration) that captures the registration image that represents the object. The collation image capturing device 12 is a device (for example, a device that includes a camera and a light source) that captures the collation image that is collated together with the registration image. The collation device 14 identifies the object by collating the registration image and the collation image. FIG. 1 illustrates a side view of the registration image capturing device 10 and the collation image capturing device 12.

For example, the registration image capturing device 10 and the collation device 14 communicate with each other via a communication path such as the internet or a local area network (LAN). Similarly, the collation image capturing device 12 and the collation device 14 communicate with each other via a communication path such as the internet or a LAN. The registration image capturing device 10 and the collation device 14 may output or receive data via a storage medium such as a portable recording medium (for example, a hard disk drive or a USB memory) without a communication path. Similarly, the collation image capturing device 12 and the collation device 14 may output or receive data via a storage medium such as a portable recording medium (for example, a hard disk drive or a USB memory) without a communication path.

Light (referred to below as “incident light 16a”) is radiated from a light source 16 such as a light emitting diode (LED) to an object 18, and the registration image capturing device 10 captures the image of light (referred to below as “reflection light 16b”) that is reflected from the object 18. Consequently, a registration image that represents the object 18 is acquired. For example, the registration image capturing device 10 and the light source 16 include exclusive equipment for registration. The surface of the object 18 has a collation region 20. The image of the collation region 20 is captured by capturing the image of the object 18. The collation region 20 is a region in which the random pattern described above is formed.

An angle φ is equal to the sum of the incident angle (that is, an angle that is formed between a straight line perpendicular to the surface of the object 18 and the incident light 16a) of the incident light 16a and the reflection angle (that is, an angle that is formed between the straight line perpendicular to the surface of the object 18 and the reflection light 16b) of the reflection light 16b. A distance WD when the registration image is acquired is a distance between the registration image capturing device 10 and the object 18.

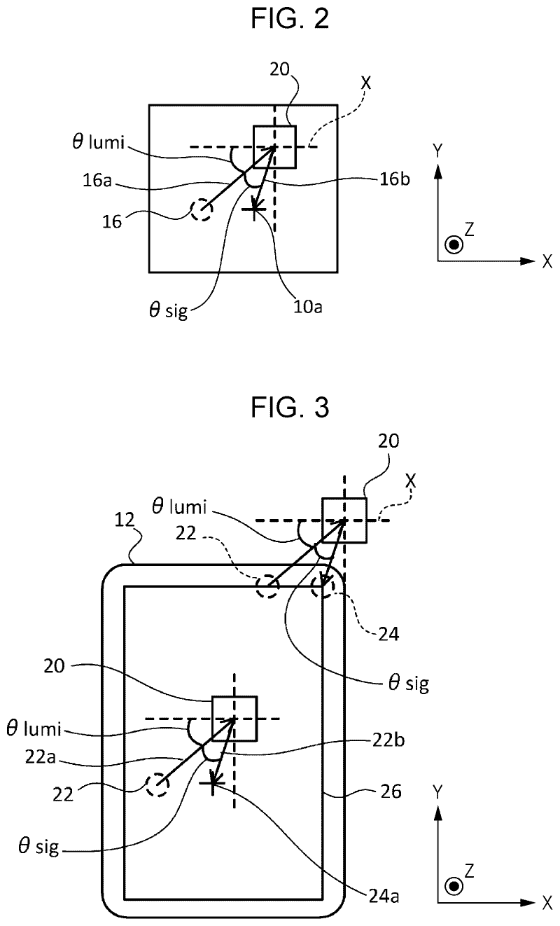

FIG. 2 illustrates the collation region 20 viewed from the registration image capturing device 10. FIG. 2 illustrates angular relationships among the registration image capturing device 10, the light source 16, and the collation region 20 when the collation region 20 is viewed from the registration image capturing device 10.

A three-dimensional rectangular coordinate system that has an X-axis, a Y-axis, and a Z-axis that are perpendicular to each other is defined here. In an example, the Z-axis is perpendicular to the surface of the object 18, and the surface of the object 18 is parallel with a plane (an XY plane) that is defined by using the X-axis and the Y-axis. The center of the collation region 20 is determined to be the origin of the three-dimensional rectangular coordinate system. The three-dimensional rectangular coordinate system is set in the registration image capturing device 10.

An angle θ sig is on the plane (the XY plane) described above and is formed between the reflection light 16b and the incident light 16a that are projected on the XY plane with a position (for example, a center) on the collation region 20 being a vertex. That is, the angle θ sig is formed between a line that connects the position of the light source 16 and the position on the collation region 20 that are projected on the XY plane to each other and a line that connects the center 10a of the registration image capturing device 10 and the position on the collation region 20 that are projected on the XY plane to each other with the position on the collation region 20 being the vertex.

An angle θ lumi is on the plane (the XY plane) described above and is formed between the incident light 16a that is projected on the XY plane and the X-axis with a position (for example, a center) on the collation region 20 being a vertex. That is, the angle θ lumi is formed between the X-axis and a line that connects the position of the light source 16 and the position on the collation region 20 that are projected on the XY plane to each other with the position on the collation region 20 being the vertex.

The acquired registration image is outputted to the collation device 14 and is stored in a memory of the collation device 14. Consequently, the registration image is registered in a registration image database (DB).

For example, the collation image capturing device 12 is a smartphone, a tablet PC, or a cellular phone and includes a light source 22 such as a LED and a camera 24. Light (referred to below as “incident light 22a”) is radiated from the light source 22 to the object 18. The camera 24 captures the image of light (referred to below as “reflection light 22b”) that is reflected from the object 18. Consequently, a collation image that represents the object 18 is acquired. For example, a user operates the collation image capturing device 12 to capture the image of the object 18.

An angle φ when the collation image is acquired is equal to the sum of the incident angle (that is, an angle that is formed between a straight line perpendicular to the surface of the object 18 and the incident light 22a) of the incident light 22a and the reflection angle (that is, an angle that is formed between the straight line perpendicular to the surface of the object 18 and the reflection light 22b) of the reflection light 22b and is substantially equal to the angle φ when the registration image is acquired. The reason is that it is necessary for positional relationships among the light source 22, the camera 24, and the object 18 to be substantially the same as positional relationships when the registration image is acquired because the random pattern that is formed on the collation region 20 changes depending on the direction in which the light is radiated. The range of the concept of “substantially the same” includes the case where the angle φ when the collation image is acquired is equal to the angle φ when the registration image is acquired and the case where a difference between the angle φ when the collation image is acquired and the angle φ when the registration image is acquired is within a permissible range (for example, a range that enables the precision of collation by using the registration image and the collation image to be target precision or higher).

A distance WD when the collation image is acquired is a distance between the collation image capturing device 12 and the object 18 and is substantially equal to the distance WD when the registration image is acquired. The range of the concept of “substantially equal” includes the case where the distance WD when the collation image is acquired is equal to the distance WD when the registration image is acquired and the case where a difference between the distance WD when the collation image is acquired and the distance WD when the registration image is acquired is within a permissible range (for example, a range that enables the precision of collation by using the registration image and the collation image to be target precision or higher).

FIG. 3 illustrates the collation region 20 viewed from the collation image capturing device 12. FIG. 3 illustrates angular relationships among the light source 22, the camera 24, and the collation region 20 when the collation region 20 is viewed from the collation image capturing device 12.

A three-dimensional rectangular coordinate system that has an X-axis, a Y-axis, and a Z-axis that are perpendicular to each other is defined here. In an example, the Z-axis is perpendicular to the surface of the object 18, and the surface of the object 18 is parallel with a plane (an XY plane) that is defined by using the X-axis and the Y-axis. The center of the collation region 20 is determined to be the origin of the three-dimensional rectangular coordinate system. The three-dimensional rectangular coordinate system is set in the collation image capturing device 12.

An angle θ sig is on the plane (the XY plane) described above and is formed between the reflection light 22b and the incident light 22a that are projected on the XY plane with a position (for example, a center) on the collation region 20 being a vertex. That is, the angle θ sig is formed between a line that connects the position of the light source 22 and the position on the collation region 20 that are projected on the XY plane to each other and a line that connects the center 24a of the camera 24 and the position on the collation region 20 that are projected on the XY plane to each other with the position on the collation region 20 being the vertex.

An angle θ lumi is on the plane (the XY plane) described above and is formed between the incident light 22a that is projected on the XY plane and the X-axis with a position (for example, a center) on the collation region 20 being a vertex. That is, the angle θ lumi is formed between the X-axis and a line that connects the position of the light source 22 and the position on the collation region 20 that are projected on the XY plane to each other with the position on the collation region 20 being the vertex.

The angle θ sig when the collation image is acquired is substantially equal to the angle θ sig when the registration image is acquired. The range of the concept of “substantially equal” includes the case where the angle θ sig when the collation image is acquired is equal to the angle θ sig when the registration image is acquired and the case where a difference between the angle θ sig when the collation image is acquired and the angle θ sig when the registration image is acquired is within a permissible range (for example, a range that enables the precision of collation by using the registration image and the collation image to be target precision or higher).

The angle θ lumi when the collation image is acquired is substantially equal to the angle θ lumi when the registration image is acquired. The range of the concept of “substantially equal” includes the case where the angle θ lumi when the collation image is acquired is equal to the angle θ lumi when the registration image is acquired and the case where a difference between the angle θ lumi when the collation image is acquired and the angle θ lumi when the registration image is acquired is within a permissible range (for example, a range that enables the precision of collation by using the registration image and the collation image to be target precision or higher).

The collation image capturing device 12 includes a display 26. An image (for example, an image that represents the collation region 20) that is captured by the camera 24 is displayed on the display 26. In an example illustrated in FIG. 3, the light source 22 and the center 24a are illustrated on the display 26 for convenience of description of the angular relationships. However, the light source 22 and the center 24a are not displayed on the display 26. The light source 22 and the camera 24 are opposite the display 26 (that is, on the back surface of the collation image capturing device 12).

The acquired collation image is outputted to the collation device 14. The collation image capturing device 12 may extract the image that represents the collation region 20 from the collation image, and the extracted image may be outputted to the collation device 14. The collation device 14 collates the registration image and the collation image and consequently determines whether an object that is represented in the collation image is the same as a registered object.

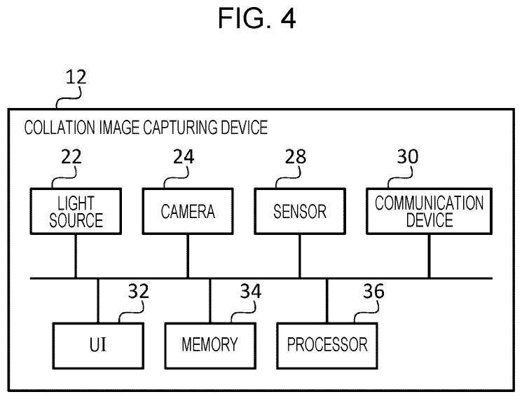

The structure of the collation image capturing device 12 will be described with reference to FIG. 4. FIG. 4 is a block diagram illustrating the structure of the collation image capturing device 12.

The collation image capturing device 12 includes the light source 22, the camera 24, a sensor 28, a communication device 30, a UI 32, a memory 34, and a processor 36.

The collation image is acquired by capturing the image by using the light source 22 and the camera 24 as described above.

The sensor 28 is a gyro-sensor and detects an angular velocity. The sensor 28 detects rotation of the collation image capturing device 12. For example, the sensor 28 may include an acceleration sensor or a global positioning system (GPS) module.

The communication device 30 includes one or multiple communication interfaces such as a communication chip and a communication circuit and has a function of transmitting information to another device and a function of receiving information from another device. The communication device 30 may have a wireless communication function such as near field communication or Wi-Fi (registered trademark) or may have a wired communication function.

The UI 32 is a user interface and includes the display 26 and an input device. Examples of the display 26 include a liquid-crystal display and an EL display. Examples of the input device include a keyboard, a mouse, input keys, and an operation panel. The UI 32 may be a UI such as a touch screen that includes the display 26 and the input device. The UI 32 may include a speaker and a microphone.

The memory 34 is a device that includes one or multiple storage areas in which data is stored. Examples of the memory 34 include a hard disk drive (HDD), a solid state drive (SSD), various memories (for example, a RAM, a DRAM, a NVRAM, and a ROM), another storage device (for example, an optical disk), and a combination thereof.

The processor 36 controls the operation of the components of the collation image capturing device 12.

The processor 36 performs a function of assisting the user to perform multiple operations on the collation image capturing device 12 such that the posture of the collation image capturing device 12 with respect to the object 18 is maintained in specific posture. The specific posture is substantially the same as the posture of the registration image capturing device 10 and the light source 16 with respect to the object 18 when the registration image is acquired. For example, the processor 36 performs the function of assisting the user to operate the collation image capturing device 12 such that the posture of the collation image capturing device 12 with respect to the object 18 is substantially the same as the specific posture. The range of the concept that the “posture is substantially the same” includes the case where the posture of the registration image capturing device 10 and the light source 16 with respect to the object 18 when the registration image is acquired is the same as the posture of the collation image capturing device 12 with respect to the object 18 when the collation image is acquired and the case where a difference between the posture of the registration image capturing device 10 and the light source 16 with respect to the object 18 when the registration image is acquired and the posture of the collation image capturing device 12 with respect to the object 18 when the collation image is acquired is within a permissible range (for example, a range that enables the precision of collation by using the registration image and the collation image to be target precision or higher).

An operation for maintaining the posture of the collation image capturing device 12 in the specific posture is divided into multiple maintenance operations, and the processor 36 performs a function of assisting the user to perform the multiple maintenance operations. The order in which the maintenance operations are performed is determined, and the processor 36 performs a function of assisting in performing the maintenance operations such that the user performs the maintenance operations in the order. In the case where one of the maintenance operations ends, the processor 36 performs a function of assisting in performing a maintenance operation subsequent to the maintenance operation. In the case where the subsequent maintenance operation ends, the processor 36 performs a function of assisting in performing a subsequent maintenance operation.

For example, the operation for maintaining the posture of the collation image capturing device 12 in the specific posture includes maintenance operations A, B, and C, and a function of maintaining the operation includes an assistance function A of assisting in performing the maintenance operation A, an assistance function B of assisting in performing the maintenance operation B, and an assistance function C of assisting in performing the maintenance operation C. This division is just an example. The operation for maintaining the posture of the collation image capturing device 12 in the specific posture may be divided into two maintenance operations or may be divided into four or more maintenance operations. Also, in this case, assistance functions of assisting the respective maintenance operations are performed.

The processor 36 performs the assistance functions A, B, and C in the order and consequently assists the user to perform the maintenance operations A, B, and C in the order. For example, the processor 36 performs the assistance function B after the maintenance operation A ends and consequently assists the user to perform the maintenance operation B, and the processor 36 performs the assistance function C after the maintenance operation B ends and consequently assists the user to perform the maintenance operation C. This order is just an example. The assistance functions may be performed in an order that differs from this order. The user may set the order.

The assistance function A is a function of assisting the user to perform the maintenance operation A on the collation image capturing device 12 such that a positional relationship between the object 18 and the collation image capturing device 12 is maintained in a specific positional relationship.

The specific positional relationship is a relationship between the position of the object 18 and the position of the camera 24 when the collation image capturing device 12 captures the image of the object 18 at an ideal capturing position and is determined based on a positional relationship between the object 18 and the registration image capturing device 10 when the registration image is acquired. For example, a three-dimensional rectangular coordinate system that has an X-axis, a Y-axis and a Z-axis is defined. The position of the object 18 and the position of the camera 24 correspond to coordinates (x, y, z) on a three-dimensional space that is represented by the three-dimensional rectangular coordinate system. The maintenance operation A is an operation of moving the collation image capturing device 12 in the X-axis, the Y-axis, or the Z-axis.

The assistance functions B and C are functions of assisting the user to operate the collation image capturing device 12 such that angles between the object 18 and the collation image capturing device 12 are maintained at specific angles.

The specific angles are ideal angles when the collation image capturing device 12 captures the image of the object 18. Specifically, the specific angles are determined by using the rotation angles (specifically, a rotation angle about the X-axis, a rotation angle about the Y-axis, and a rotation angle about the Z-axis) of the registration image capturing device 10 and the light source 16 with respect to the object 18 when the registration image is acquired.

For example, the Z-axis is determined as an axis perpendicular to the surface of the object 18. An ideal rotation angle about the Z-axis is a rotation angle about the Z-axis when the collation image capturing device 12 captures the image of the object 18 at the ideal capturing position.

The assistance function B is a function of assisting the user to perform the maintenance operation B on the collation image capturing device 12 such that the rotation angle of the collation image capturing device 12 about the Z-axis with respect to the object 18 is maintained at the ideal rotation angle about the Z-axis. Accurately, the rotation angle at this time corresponds to the rotation angles of the light source 22 and the camera 24 and is determined based on the angles θ sig and θ lumi when the registration image is acquired. The maintenance operation B is an operation for rotating the collation image capturing device 12 about the Z-axis.

An ideal rotation angle about the X-axis is the rotation angle about the X-axis when the collation image capturing device 12 captures the image of the object 18 at the ideal capturing position. An ideal rotation angle about the Y-axis is the rotation angle about the Y-axis when the collation image capturing device 12 captures the image of the object 18 at the ideal capturing position.

The assistance function C is a function of assisting the user to perform the maintenance operation C on the collation image capturing device 12 such that the rotation angle of the collation image capturing device 12 about the X-axis with respect to the object 18 is maintained at the ideal rotation angle about the X-axis and such that the rotation angle of the collation image capturing device 12 about the Y-axis with respect to the object 18 is maintained at the ideal rotation angle about the Y-axis. Accurately, the rotation angles at this time correspond to the rotation angles of the light source 22 and the camera 24 and are determined based on the angle φ when the registration image is acquired. The maintenance operation C includes an operation of rotating the collation image capturing device 12 about the X-axis and an operation of rotating the collation image capturing device 12 about the Y-axis.

In an example, the assistance functions are performed in the order of the assistance functions A, B, and C. Regarding the assistance function A and the assistance function B, the assistance function A is performed before the assistance function B. Accordingly, the assistance function A corresponds to a first function, the assistance function B corresponds to a second function, the maintenance operation A corresponds to a first operation, and the maintenance operation B corresponds to a second operation. Regarding the assistance function B and the assistance function C, the assistance function B is performed before the assistance function C. Accordingly, the assistance function B corresponds to the first operation, the assistance function C corresponds to the second function, the maintenance operation B corresponds to the first operation, and the maintenance operation C corresponds to the second operation. If the order in which the assistance functions A, B, and C are performed changes, a relationship among the assistance functions and a relationship among the maintenance operations change depending on the change. The assistance functions B and C may be determined as a single assistance function, and the assistance functions B and C may be simultaneously performed after or before the assistance function A.

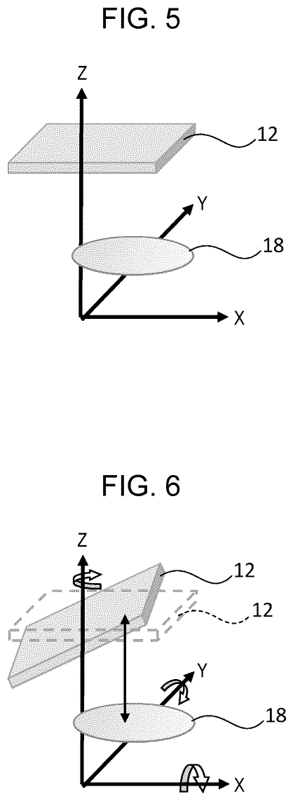

The ideal capturing position will be described with reference to FIG. 5. FIG. 5 illustrates the collation image capturing device 12 and the object 18 in the three-dimensional space. The X-axis, the Y-axis, and the Z-axis that the three-dimensional rectangular coordinate system has are illustrated. The ideal capturing position in the three-dimensional space corresponds to the coordinates (x, y, z) of the collation image capturing device 12 with the angles between the collation image capturing device 12 and the object 18 maintained at constant angles. If angles between the registration image capturing device 10 and the object 18 when the registration image is acquired are 0°, the constant angles are 0°. For example, when the collation image capturing device 12 is moved on the XY plane, the object 18 that moves is displayed on the display 26, and when the collation image capturing device 12 is moved along the Z-axis, the size of the object 18 that is displayed on the display 26 changes.

The ideal angles will be described with reference to FIG. 6. FIG. 6 illustrates the collation image capturing device 12 and the object 18 in the three-dimensional space. The X-axis, the Y-axis, and the Z-axis that the three-dimensional rectangular coordinate system has are illustrated. The ideal angles in the three-dimensional space are the rotation angles (the rotation angle of the collation image capturing device 12 about the X-axis, the rotation angle of the collation image capturing device 12 about the Y-axis, and the rotation angle of the collation image capturing device 12 about the Z-axis) with the distance between the collation image capturing device 12 and the object 18 maintained at a constant distance (for example, the distance WD when the registration image is acquired).

The three-dimensional rectangular coordinate system illustrated in FIG. 5 and the three-dimensional rectangular coordinate system illustrated in FIG. 6 may be the same or may differ from each other. The three-dimensional rectangular coordinate systems may be set depending on the collation image capturing device 12.

The assistance function A may include a function of statically or dynamically inducing the user to perform the maintenance operation A such that the positional relationship between the object 18 and the collation image capturing device 12 is maintained in the specific positional relationship.

Similarly, the assistance functions B and C may include a function of statically or dynamically inducing the user to perform the maintenance operations B and C such that the angles between the object 18 and the collation image capturing device 12 are maintained at the specific angles.

The assistance function A includes a function of outputting information (for example, information about a region, coordinates, or a size) that represents the whole of the object 18, a part of the object 18, or the ideal capturing position such that the positional relationship between the object 18 and the collation image capturing device 12 is maintained in the specific positional relationship.

For example, the assistance function A includes a function of outputting a guide A for assisting in performing the maintenance operation A by using a figure, a character string, or a voice. The figure is a frame imitating the whole of the outer shape of the object 18 or a part thereof, a line, a symbol mark, or another figure. For example, the character string may be a logo. The assistance function A may include a function of displaying the ideal capturing position that is emphasized by using, for example, a color, brightness, or contrast. Specifically, the processor 36 may cause the display 26 to display a figure or a character string that represents the guide A or may cause a voice that represents the guide A to sound from the speaker. The processor 36 may cause the display 26 to display the figure or the character string that represents the guide A and may cause the voice that represents the guide A to sound from the speaker

The assistance functions B and C include a function of expressing the ideal angles by using the whole of the object 18, a part of the object 18, or another indicator such that the angles between the object 18 and the collation image capturing device 12 are maintained at the specific angles. For example, the assistance function B includes a function of outputting a guide B for assisting in performing the maintenance operation B by using a figure, a character string, or a voice. The assistance function C includes a function of outputting a guide C for assisting in performing the maintenance operation C by using a figure, a character string, or a voice. The figure is a frame imitating the whole of the outer shape of the object 18 or a part thereof, a line, a symbol mark, or another figure. For example, the character string may be a logo. Specifically, the processor 36 may cause the display 26 to display a figure or a character string that represents the guide B or may cause a voice that represents the guide B to sound from the speaker. The processor 36 may cause the display 26 to display the figure or the character string that represents the guide B and may cause the voice that represents the guide B to sound from the speaker. Similarly, the processor 36 may cause the display 26 to display a figure or a character string that represents the guide C or may cause a voice that represents the guide C to sound from the speaker. The processor 36 may cause the display 26 to display the figure or the character string that represents the guide C and may cause the voice that represents the guide C to sound from the speaker. The assistance function C may include a function of outputting an indicator that represents the state of the collation image capturing device 12 that rotates by using a figure (for example, a symbol mark), a character string or a voice.

Methods of outputting the respective guides A, B, and C (for example, displaying a figure or a character string or outputting a voice) may be the same or may differ from each other.

In an example in which the maintenance operation A is statically induced, a stationary figure or a stationary character string is displayed. In an example in which the maintenance operation A is dynamically induced, the guide A is outputted by using a voice in conjunction with the movement (for example, movement along the X-axis, the Y-axis, or the Z-axis or rotation about the Z-axis) of the collation image capturing device 12.

In an example in which the maintenance operations B and C are statically induced, a stationary figure or a stationary character string is displayed. In an example in which the maintenance operations B and C are dynamically induced, a figure or a character string that represents the degree of rotation (for example, the degree of rotation about the X-axis, the degree of rotation about the Y-axis, or the degree of rotation about the Z-axis) of the collation image capturing device 12 is displayed, or a voice that represents the degree of rotation is outputted. For example, the guide C includes a guide that dynamically represents the state of the collation image capturing device 12 by using information that is acquired by the sensor 28, and an example in which the maintenance operation C is dynamically induced corresponds to displaying the guide.

After a maintenance operation ends, the processor 36 performs an assistance function for assisting in performing a subsequent maintenance operation as described above. The range of the concept that the “maintenance operation ends” includes the case where the posture of the collation image capturing device 12 is maintained in posture that is maintained by the maintenance operation, the case where the user requests that the maintenance operation subsequent to the maintenance operation be started, and the case where a time during which the assistance function for assisting in performing the maintenance operation becomes equal to or more than a threshold. The request from the user is received by the collation image capturing device 12 via, for example, the UI 32.

In the case where at least one of the multiple maintenance operations ends, the processor 36 may perform an emphasis process to represent the case.

In the case where the maintenance operation A ends, the processor 36 performs an emphasis process A to represents that the maintenance operation A ends. Specifically, in the case where the position of the collation image capturing device 12 with respect to the object becomes substantially the same as the ideal capturing position, the processor 36 performs the emphasis process A. The range of the concept that the “positions are substantially the same” includes the case where the position of the collation image capturing device 12 with respect to the object is the same as the ideal capturing position and the case where a difference therebetween is within a permissible range (for example, a range that enables the precision of collation by using the registration image and the collation image to be target precision or higher).

Also, in the case where the maintenance operation A ends in response to the request from the user, or in the case where a time during which the assistance function A is performed becomes equal to or more than a threshold, and the assistance function A ends, the processor 36 may perform the emphasis process A. In the case where the assistance function A ends in response to the request from the user, or in the case where the time during which the assistance function A is performed becomes equal to or more than the threshold, and the assistance function A ends, the processor 36 may not perform the emphasis process A.

Examples of the emphasis process A include a process of changing the color of the guide A that is displayed, a process of outputting a sound or a character string that represents that the positional relationship becomes the specific positional relationship, a process of displaying an image (for example, a symbol mark) that represents that the positional relationship becomes the specific positional relationship, a process of vibrating the collation image capturing device 12, a process of causing a light in the collation image capturing device 12 to blink (for example, a process of causing the display 26 to blink), and a combination of multiple processes among these.

In the case where the maintenance operation B ends, the processor 36 performs the emphasis process B to represents that the maintenance operation B ends. Specifically, in the case where the rotation angle of the collation image capturing device 12 about the Z-axis with respect to the object becomes substantially equal to the ideal rotation angle about the Z-axis, the processor 36 performs the emphasis process B to represents the case. The range of the concept that the “rotation angles are substantially equal” includes the case where the rotation angle of the collation image capturing device 12 about the Z-axis with respect to the object is equal to the ideal rotation angle about the Z-axis and the case where a difference between the rotation angles is within a permissible range (for example, a range that enables the precision of collation by using the registration image and the collation image to be target precision or higher).

Also, in the case where the maintenance operation B ends in response to the request from the user, or in the case where a time during which the assistance function B is performed becomes equal to or more than a threshold, and the assistance function B ends, the processor 36 may perform the emphasis process B. In the case where the assistance function B ends in response to the request from the user, or in the case where the time during which the assistance function B is performed becomes equal to or more than the threshold, and the assistance function B ends, the processor 36 may not perform the emphasis process B.

Examples of the emphasis process B include a process of changing the color of the guide B that is displayed, a process of outputting a sound or a character string that represents that the rotation angle about the Z-axis becomes the ideal rotation angle, a process of displaying an image (for example, a symbol mark) that represents that the rotation angle about the Z-axis becomes the ideal rotation angle, a process of vibrating the collation image capturing device 12, a process of causing the light in the collation image capturing device 12 to blink, and a combination of multiple processes among these.

In the case where the maintenance operation C ends, the processor 36 performs the emphasis process C to represents that the maintenance operation C ends. Specifically, in the case where the rotation angle of the collation image capturing device 12 about the X-axis with respect to the object becomes substantially equal to the ideal rotation angle about the X-axis, and the rotation angle about the Y-axis becomes substantially equal to the ideal rotation angle about the Y-axis, the processor 36 performs the emphasis process C to represents the case. The range of the concept that the “rotation angles are substantially equal” includes the case where the rotation angle of the collation image capturing device 12 about the X-axis with respect to the object is equal to the ideal rotation angle about the X-axis and the case where a difference between the rotation angles is within a permissible range (for example, a range that enables the precision of collation by using the registration image and the collation image to be target precision or higher). The same is true for the rotation angle about the Y-axis.

Examples of the emphasis process C include a process of changing the color of the guide C that is displayed, a process of outputting a sound or a character string that represents that the rotation angles about the X-axis and the Y-axis become the ideal rotation angles, a process of displaying an image (for example, a symbol mark) that represents that the rotation angles about the X-axis and the Y-axis become the ideal rotation angles, a process of vibrating the collation image capturing device 12, a process of causing the light in the collation image capturing device 12 to blink (for example, a process of causing the display 26 to blink), and a combination of multiple processes among these.

The emphasis processes A, B, and C may be the same or may differ from each other. For example, the emphasis process A is a process of changing the color of the guide A that is displayed, and the emphasis process B is a process of changing the color of the guide B that is displayed, and the emphasis process C is a process of vibrating the collation image capturing device 12. This is just an example, and another combination is acceptable. The user may readily recognize whether the maintenance operation A, B, or C ends by changing the emphasis processes A, B, and C from each other, unlike the case where these are the same.

In the case where all of the maintenance operations A, B, and C end, the processor 36 may perform an emphasis process.

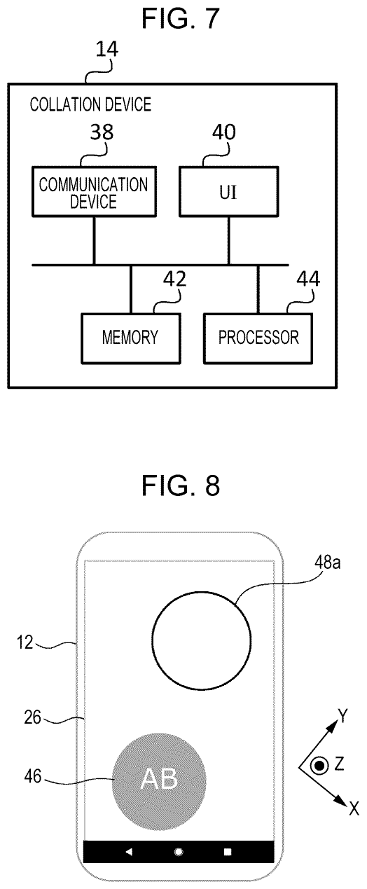

The structure of the collation device 14 will now be described with reference to FIG. 7. FIG. 7 is a block diagram illustrating the structure of the collation device 14.

The collation device 14 includes a communication device 38, a UI 40, a memory 42, and a processor 44. An example of the collation device 14 is a device such as a personal computer or a server.

The communication device 38 includes one or multiple communication interfaces such as a communication chip and a communication circuit and has a function of transmitting information to another device and a function of receiving information from another device. The communication device 38 may have a wireless communication function such as near field communication or Wi-Fi (registered trademark) or may have a wired communication function.

The UI 40 is a user interface and includes a display and an input device. Examples of the display include a liquid-crystal display and an EL display. Examples of the input device include a keyboard, a mouse, input keys, and an operation panel. The UI 40 may be a UI such as a touch screen that includes the display and the input device.

The memory 42 is a device that includes one or multiple storage areas in which data is stored. Examples of the memory 42 include a hard disk drive (HDD), a solid state drive (SSD), various memories (for example, a RAM, a DRAM, a NVRAM, and a ROM), another storage device (for example, an optical disk), and a combination thereof.

The registration image is stored in the memory 42. For example, the registration image DB is created by using the memory 42, and identification information (for example, identification (ID)) for uniquely identifying the object 18 and the registration image are associated with each other and are registered in the registration image DB.

The processor 44 controls the operation of the components of the collation device 14.

The processor 44 receives the registration image that is acquired by the registration image capturing device 10, associates the registration image and the identification information about the object 18 with each other, and registers these in the registration image DB. The processor 44 receives the collation image that is acquired by the collation image capturing device 12, collates the collation image and the registration image that is registered in the registration image DB, and outputs information that represents the result of collation. For example, the information that represents the result of collation is outputted to the collation image capturing device 12.

Specifically, the processor 44 reads the registration image from the registration image DB and calculates similarity between the read registration image and the collation image. The similarity is calculated by using a known algorithm. In the case where the calculated similarity exceeds a threshold, the processor 44 determines that the registration image matches the collation image. In the case where the calculated similarity does not exceed the threshold, the processor 44 determines that the registration image does not match the collation image. The processor 44 outputs the result of determination as the result of collation.

Image collation has an error rate due to, for example, a variation or a quantization error in the input of the camera that is used for capturing the image. The error rate includes a false rejection rate that is probability that a true case is determined to be false and a false acceptance rate that is probability that a false case is determined to be true. There is a trade-off relationship between these, and when one decreases, the other increases. Accordingly, the threshold is set such that a target for collation has the minimum loss.

Specific examples of the guide A will now be described with reference to FIG. 8. FIG. 8 illustrates the display 26 of the collation image capturing device 12. The three-dimensional rectangular coordinate system that has the X-axis, the Y-axis, and the Z-axis that are perpendicular to each other is set in the collation image capturing device 12. An axis perpendicular to the surface of an object 46 is defined as the Z-axis.

In an example described herein, the camera 24 of the collation image capturing device 12 captures the image of the object 46 on which a character string “AB” (for example, a logo) is drawn, and an image that represents the object 46 is displayed on the display 26.

The processor 36 causes the display 26 to display a guide 48a with the result that the assistance function A is performed. The guide 48a is an example of the guide A and is a frame-shaped figure imitating the outer shape of the object 46. In an example described herein, the outer shape of the object 46 is circular, and the guide 48a has a circular shape. A position at which the guide 48a is displayed on the display 26 corresponds to the ideal capturing position in the three-dimensional space and is determined based on the position (x, y, z) of the registration image capturing device 10 when the registration image capturing device 10 captures the image of the object 46 at the ideal capturing position. The size (that is, a frame size) of the guide 48a is determined based on the distance WD when the registration image capturing device 10 captures the image of the object 46. Data the represents the guide 48a is generated by the registration image capturing device 10, the collation image capturing device 12, the collation device 14 or another device and is stored in the memory 34 of the collation image capturing device 12.

The guide 48a functions as a guide for causing the position of the camera 24 to match the position of the object 46 in the three-dimensional space (that is, a guide for assisting in performing the maintenance operation A). The guide 48a is a guide for statically inducing the positions to be matched.

The user changes the position (that is, coordinates (x, y, z) in the three-dimensional space) of the collation image capturing device 12 such that the position at which the object 46 is displayed on the display 26 substantially matches the position at which the guide 48a is displayed. That is, the user moves the collation image capturing device 12 along the X-axis, the Y-axis, or the Z-axis. The range of the concept of the “positions of display substantially match each other” includes the case where the positions of display match each other and the case where a difference between the positions of display is within a permissible range (for example, a range that enables the precision of collation by using the registration image and the collation image to be target precision or higher).

In the case where the maintenance operation A ends, the processor 36 performs the assistance function B and consequently outputs the guide B. For example, in the case where the position at which the object 46 is displayed substantially matches the position at which the guide 48a is displayed, the processor 36 performs the assistance function B. In the case where the user requests that the maintenance operation B be started (for example, in the case where the user taps the display 26), or in the case where the time during which the assistance function A is performed becomes equal to or more than the threshold, the processor 36 may perform the assistance function B.

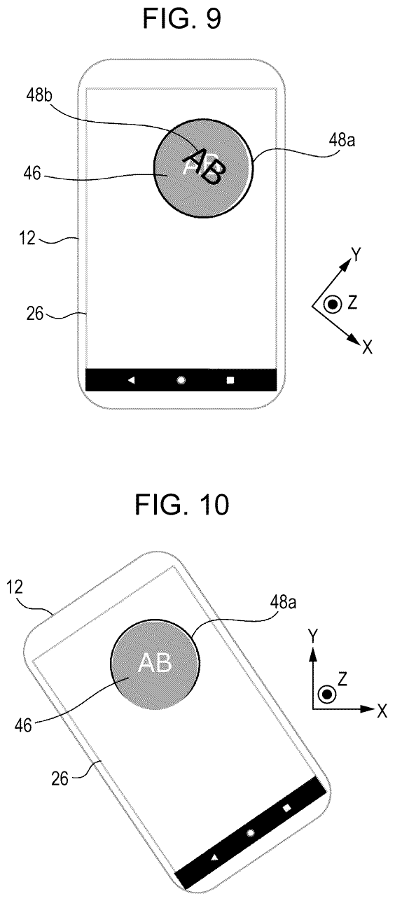

Specific examples of the guide B will now be described with reference to FIG. 9. FIG. 9 illustrates the display 26 of the collation image capturing device 12.

The processor 36 performs the assistance function B and consequently causes the display 26 to display a guide 48b. The guide 48b is an example of the guide B and is displayed in the guide 48a. The guide 48b is a character string that is the same as the character string “AB” that is drawn on the object 46. The direction (that is, the rotation angle about the Z-axis) of the guide 48b on the XY plane is determined based on the rotation angle of the registration image capturing device 10 about the Z-axis when the registration image capturing device 10 captures the image of the object 46 at the ideal capturing position. The size of the guide 48b is determined based on the distance WD when the registration image capturing device 10 captures the image of the object 46. Data that represents the guide 48b is generated by the registration image capturing device 10, the collation image capturing device 12, the collation device 14 or another device and is stored in the memory 34 of the collation image capturing device 12.

The guide 48b functions as a guide for causing the rotation angle of the collation image capturing device 12 about the Z-axis to match the rotation angle of the object 46 about the Z-axis (that is, a guide for assisting in performing the maintenance operation B). A position at which the guide 48b is displayed is determined based on the ideal capturing position, and accordingly, the guide 48b may function as the guide for causing the position of the camera 24 to match the position of the object 46 in the three-dimensional space. The guide 48b is a guide for statically inducing the rotation to be matched.

In a state illustrated in FIG. 9, the position at which the object 46 is displayed substantially matches the position at which the guide 48a is displayed. However, the direction of the character string “AB” that is drawn on the object 46 does not substantially match the direction of the guide 48b. In this case, the user changes the rotation angle of the collation image capturing device 12 about the Z-axis such that the direction of the character string “AB” that is drawn on the object 46 substantially matches the direction of the guide 48b. That is, the user rotates the collation image capturing device 12 about the Z-axis. The range of the concept that the “directions substantially match each other” includes the case where the directions match each other and the case where a difference between the directions is within a permissible range (for example, a range that enables the precision of collation by using the registration image and the collation image to be target precision or higher).

In a state illustrated in FIG. 10, the direction of the character string on the object 46 substantially matches the direction of the guide 48b. Consequently, the maintenance operation B ends.

In the case where the maintenance operation A ends, the processor 36 may cause the display to display the guide 48b and may cause the display 26 to display the guide 48a. Examples thereof are illustrated in FIG. 9 and FIG. 10. In another example, in the case where the maintenance operation A ends, the processor 36 may not cause the display 26 to display the guide 48a. That is, the processor 36 may not cause a guide for the assistance function that ends to be displayed.

In the case where the maintenance operation B ends, the processor 36 performs the assistance function C and consequently outputs the guide C. The guide C will be described later.

In the example illustrated in FIG. 9, the processor 36 causes the guide 48b that functions as the guide B to be displayed in the guide 48a that functions as the guide A. Consequently, the guide B is displayed in the guide A. A change in the line of sight of the user when the guides A and B are viewed may be decreased in a manner in which the guide B is thus displayed in the guide A, unlike the case where the guide B is displayed outside the guide A. The processor 36 may cause the guide C to be displayed in the guide A.

Specific examples will now be described.

### First Example

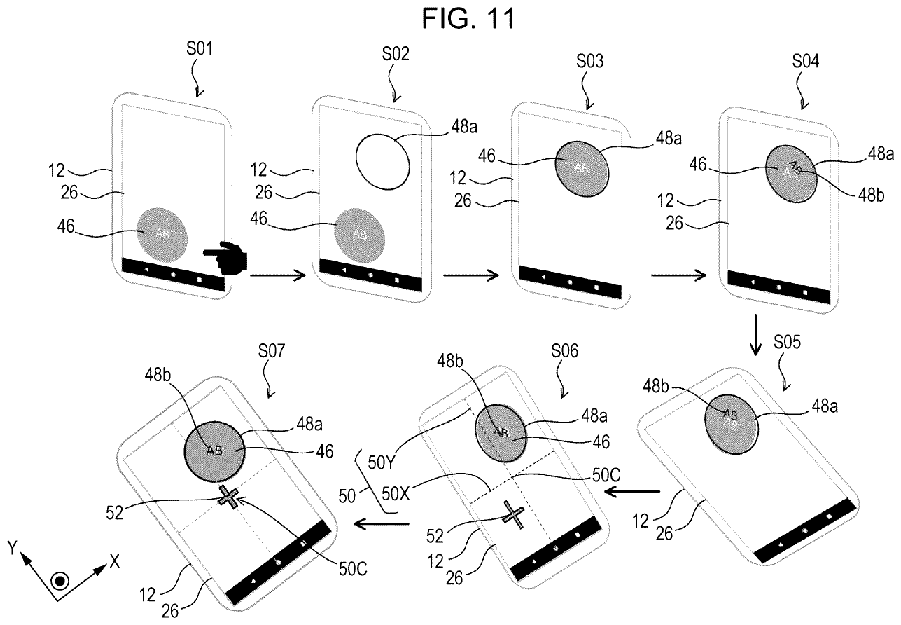

A first example will be described with reference to FIG. 11. FIG. 11 illustrates the display 26 of the collation image capturing device 12. The three-dimensional rectangular coordinate system that has the X-axis, the Y-axis, and the Z-axis that are perpendicular to each other is set in the collation image capturing device 12. An axis perpendicular to the surface of the object 46 is defined as the Z-axis. The image of the object 46 is captured as in the examples illustrated in FIG. 8 to FIG. 10.

When the user operates the collation image capturing device 12 and requests that an assistance function be performed, the processor 36 of the collation image capturing device 12 performs the assistance function as described below. For example, when the user operates the collation image capturing device 12 and request that application software that fulfills the assistance function be started up, the processor 36 runs the application software and consequently performs the assistance function.

The camera 24 of the collation image capturing device 12 first captures the image of the object 46, and the display 26 displays the object 46 (a step S01). The screen of the display 26 in this state corresponds to an initial screen.

When the user operates the collation image capturing device 12 and requests that a maintenance operation be started with the display 26 displaying the object 46, the processor 36 performs the assistance function A and consequently causes the display 26 to display the guide 48a (a step S02). For example, when the user taps the screen of the display 26 or requests that the operation be started by using a voice, the processor 36 causes the display 26 to display the guide 48a.

The user changes the position (that is, coordinates (x, y, z) in the three-dimensional space) of the collation image capturing device 12 such that the position at which the object 46 is displayed on the display 26 substantially matches the position at which the guide 48a is displayed (a step S03). That is, the user moves the collation image capturing device 12 along the X-axis, the Y-axis, or the Z-axis. This operation of positional matching corresponds to the maintenance operation A. In an example illustrated in FIG. 11, the position at which the object 46 is displayed substantially matches the position at which the guide 48a is displayed at the step S03. It may be said that in this state, a positional relationship between the object 46 and the collation image capturing device 12 is maintained in a specific positional relationship. In the case where the position at which the object 46 is displayed substantially matches the position at which the guide 48a is displayed, the processor 36 determines that the maintenance operation A ends. The processor 36 may perform the emphasis process A (for example, a process of changing the color of the guide 48a that is displayed).

In the case where the maintenance operation A ends, the processor 36 performs the assistance function B and consequently causes the display 26 to display the guide 48b (a step S04). In the case where the position at which the object 46 is displayed does not substantially match the position at which the guide 48a is displayed, but the time during which the assistance function A is performed becomes equal to or more than the threshold, or in the case where the user requests that a subsequent assistance function (for example, the assistance function B) be performed, the processor 36 may perform the assistance function B. In the example illustrated in FIG. 11, the guide 48b is displayed in the guide 48a.

The user changes the rotation angle of the collation image capturing device 12 about the Z-axis such that the direction of the character string “AB” that is drawn on the object 46 substantially matches the direction of the guide 48b (a step S05). That is, the user rotates the collation image capturing device 12 about the Z-axis. This operation corresponds to the maintenance operation B. In the example illustrated in FIG. 11, the direction of the character string “AB” that is drawn on the object 46 substantially matches the direction of the guide 48b at the step S05. It may be said that in this state, the rotation angle about the Z-axis between the object 46 and the collation image capturing device 12 is maintained in the specific angle. In the case where the direction of the character string “AB” that is drawn on the object 46 substantially matches the direction of the guide 48b, the processor 36 determines that the maintenance operation B ends. The processor 36 may perform the emphasis process B (for example, a process of changing the color of the guide 48b that is displayed).

In the case where the maintenance operation B ends, the processor 36 performs the assistance function C and consequently causes the display 26 to display the guide C (a step S06). For example, a coordinate axis figure 50 and a mark 52 are examples of the guide C, and the processor 36 causes the display 26 to display the coordinate axis figure 50 and the mark 52. In the case where the direction of the character string “AB” that is drawn on the object 46 does not substantially match the direction of the guide 48b, but the time during which the assistance function B is performed becomes equal to or more than the threshold, or in the case where the user requests that a subsequent assistance function (for example, the assistance function C) be performed, the processor 36 may perform the assistance function C. The guide C will now be described.

The coordinate axis figure 50 contains a guide 50X that represents the X-axis and a guide 50Y that represents the Y-axis. An intersection point 50C between the guide 50X and the guide 50Y corresponds to the origin of the three-dimensional rectangular coordinate system. A position at which the intersection point 50C is displayed on the display 26 is determined based on the ideal angles in the three-dimensional space and is specifically determined based on the angle φ when the registration image is acquired.

The mark 52 is a figure that represents the rotation angles (specifically, the rotation angle about the X-axis and the rotation angle about the Y-axis) of the collation image capturing device 12 that are acquired by the gyro-sensor that is included in the sensor 28. The processor 36 causes the display 26 to display the mark 52 at a position associated with the rotation angles that are acquired by the gyro-sensor. When the direction of the collation image capturing device 12 changes, the gyro-sensor detects the change, and the processor 36 changes a position at which the mark 52 is displayed in response to the change.

The position at which the mark 52 is displayed changes depending on the direction of the collation image capturing device 12, and accordingly, the mark 52 is a guide for dynamically inducing the rotation angles about the X-axis and the Y-axis to be matched. The coordinate axis figure 50 is a static guide that represents the coordinate axes for the mark 52 that functions as a dynamic guide. The coordinate axis figure 50 and the mark 52 function as the guide for inducing the user such that the collation image capturing device 12 captures the image of the object 46 at the ideal angles as described above. Data that represents the coordinate axis figure 50 and the mark 52 is generated by the registration image capturing device 10, the collation image capturing device 12, the collation device 14, or another device and is stored in the memory 34 of the collation image capturing device 12.

The user changes the rotation angles of the collation image capturing device 12 about the X-axis and the Y-axis such that the position at which the mark 52 is displayed substantially matches the position at which the intersection point 50C is displayed (a step S07). The range of the concept of the “positions of display substantially match each other” includes the case where the positions of display match each other and the case where a difference between the positions of display is within a permissible range (for example, a range that enables the precision of collation by using the registration image and the collation image to be target precision or higher). In the example illustrated in FIG. 11, the position at which the mark 52 is displayed substantially matches the position at which the intersection point 50C is displayed at the step S07. It may be said that in this state, the rotation angle about the X-axis between the object 46 and the collation image capturing device 12 is maintained at the specific angle, and the rotation angle about the Y-axis between the object 46 and the collation image capturing device 12 is maintained at the specific angle. In the case where the position at which the mark 52 is displayed substantially matches the position at which the intersection point 50C is displayed, the processor 36 determines that the maintenance operation C ends. The processor 36 may perform the emphasis process C (for example, a process of changing the color of the mark 52 that is displayed).

It may be said that the positional relationship between the object 46 and the collation image capturing device 12 is the specific positional relationship, and angles between the object 46 and the collation image capturing device 12 are the specific angles at the step S07. That is, it may be said that the position of the collation image capturing device 12 is maintained at the ideal capturing position, and the angles of the collation image capturing device 12 with respect to the object 46 are maintained at the ideal angles.

The processor 36 may cause the mark 52 that is an example of the guide C to be displayed in the guide 48a in the form of a frame or to be displayed in a predetermined range based on the position at which the guide 48a is displayed.

In the examples described above, the display 26 displays the guides A, B, and C. In another example, the processor 36 may cause the display 26 to display the guides A, B, and C and may output the guides A, B, and C by using voices. For example, the processor 36 outputs the direction in which the collation image capturing device 12 is moved and the distance thereof by using a voice for causing the position at which the object 46 is displayed to match the position at which the guide 48a is displayed, outputs the rotation angle about the Z-axis by using a voice for causing the direction of the character string that is drawn on the object 46 to match the direction of the guide 48b, or outputs the rotation angles about the X-axis and the Y-axis by using a voice for causing the position at which the mark 52 is displayed to match the intersection point 50C. These are examples of the output of the guides. For example, the processor 36 may freely combine the display of a figure, the output of a voice, and the display of a character string.

Performing the assistance functions A, B, and C in order enables the user to perform the maintenance operations A, B, and C in order such that the posture of the collation image capturing device 12 with respect to the object matches the ideal posture.

In the case where the posture that is maintained by performing a preceding maintenance operation changes when a subsequent maintenance operation is performed after the preceding maintenance operation ends, the processor 36 may provide a guide for prompting the user to perform the preceding maintenance operation.

Examples the guide include the output of a message for recommending the user to perform the preceding maintenance operation (for example, the message is displayed, or the guide is provided by using a voice), the display of a button for performing the preceding assistance function, or performing an emphasis process. The emphasis process for the guide differs from the emphasis processes A, B, and C described above. For example, in the case where the emphasis process is to vibrate, the processor 36 changes the form or degree (for example, the magnitude or frequency of the vibration) of the vibration between the emphasis process for the guide and the emphasis processes A, B, and C.

For example, in the case where the position at which the object 46 is displayed does not substantially match the position at which the guide 48a is displayed when the subsequent maintenance operation B is performed after the position at which the object 46 is displayed substantially matches the position at which the guide 48a is displayed, and the maintenance operation A ends, the processor 36 provides a guide for prompting the user to perform the maintenance operation A. A state in which the position at which the object 46 is displayed does not substantially match the position at which the guide 48a is displayed corresponds to a state in which the posture that is maintained by performing the maintenance operation A changes. For example, the processor 36 causes the display 26 to display the message for recommending the user to perform the maintenance operation A.

Similarly, in the case where the direction of the character string that is drawn on the object 46 does not substantially match the direction of the guide 48b when the subsequent maintenance operation C is performed after the direction of the character string that is drawn on the object 46 substantially matches the direction of the guide 48b, and the maintenance operation B ends, the processor 36 provides a guide for prompting the user to perform the maintenance operation B. A state in which the direction of the character string that is drawn on the object 46 does not substantially match the direction of the guide 48b corresponds to a state in which the posture that is maintained by performing the maintenance operation B changes.

Similarly, in the case where the position at which the mark 52 is displayed does not substantially match the position at which the intersection point 50C is displayed after the position at which the mark 52 is displayed substantially matches the position at which the intersection point 50C is displayed, and the maintenance operation C ends, the processor 36 provides a guide for prompting the user to perform the maintenance operation C. A state in which the position at which the mark 52 is displayed does not substantially match the position at which the intersection point 50C is displayed corresponds to a state in which the posture that is maintained by performing the maintenance operation C changes.

In the case where the display 26 does not display the object 46, or in the case where the degree of misalignment becomes equal to or more than a threshold, the processor 36 may provide a guide for performing the preceding maintenance operation.

In the example illustrated in FIG. 11, the assistance functions A, B, and C are performed in this order. However, the order is an example and may be freely changed. The user may set the order by operating the collation image capturing device 12.

### Second Example

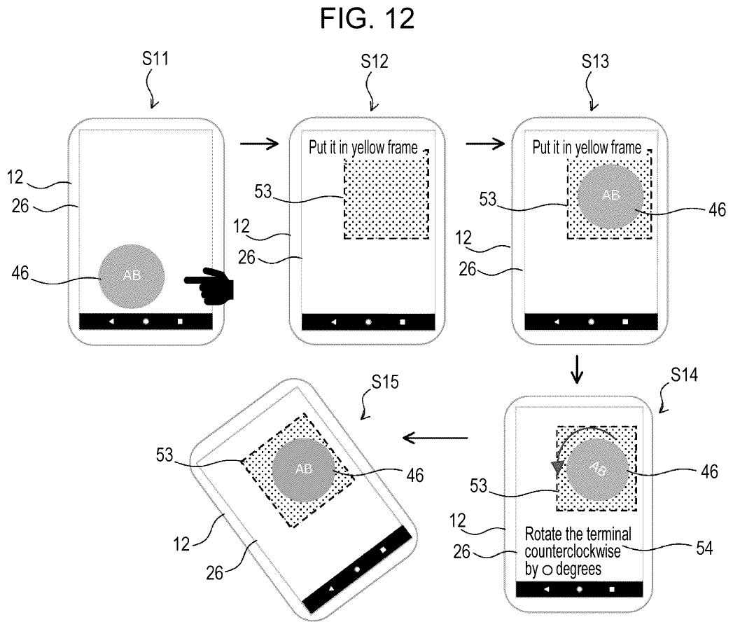

A second example will be described with reference to FIG. 12. FIG. 12 illustrate the display 26 of the collation image capturing device 12. The three-dimensional rectangular coordinate system that has the X-axis, the Y-axis, and the Z-axis that are perpendicular to each other is set in the collation image capturing device 12. The axis perpendicular to the surface of the object 46 is defined as the Z-axis. The image of the object 46 is captured as in examples illustrated in FIG. 8 to FIG. 10.

When the user operates the collation image capturing device 12 and requests that an assistance function be performed, the processor 36 of the collation image capturing device 12 performs the assistance function as described below.

The camera 24 of the collation image capturing device 12 first captures the image of the object 46, and the display 26 displays the object 46 (a step S11). The screen of the display 26 in this state corresponds to an initial screen.

When the user operates the collation image capturing device 12 and requests that a maintenance operation be performed with the display 26 displaying the object 46, the processor 36 performs the assistance function A and consequently causes the display 26 to display a guide 53 that is an example of the guide A (a step S12). For example, when the user taps the screen of the display 26 or requests that the operation be performed by using a voice, the processor 36 causes the display 26 to display the guide 53.

The guide 53 has a rectangular frame shape. The guide 53 is displayed at a position that corresponds to the ideal capturing position. In an example described herein, the size of the guide 53 is larger than the size of the object 46 that is displayed when the collation image capturing device 12 is installed at the ideal capturing position. However, the size is just an example. The size of the guide 53 may be determined such that the object 46 is in contact with the guide 53 inside the guide 53, or the size of the guide 53 may be smaller than the size of the object 46.

A region in the guide 53 is displayed by using a specific color. In an example illustrated in FIG. 12, the specific color is yellow but may be another color.

The processor 36 causes the display 26 to display a message (for example, “Put it in the yellow frame”) for assisting the user to perform the maintenance operation A such that the object 46 is displayed in the guide 53. The processor 36 may not cause the message to be displayed or may output the message by using a voice.

The user changes the position (that is, coordinates (x, y, z) in the three-dimensional space) of the collation image capturing device 12 such that the position at which the object 46 is displayed on the display 26 substantially matches the position at which the guide 53 is displayed (a step S13). Specifically, the user changes the position of the collation image capturing device 12 such that the object 46 is displayed in the guide 53. This operation corresponds to the maintenance operation A. In the example illustrated in FIG. 12, the object 46 is displayed in the guide 53 at the step S13. It may be said that in this state, the positional relationship between the object 46 and the collation image capturing device 12 is maintained in the specific positional relationship. In the case where the object 46 is displayed in the guide 53, the processor 36 determines that the maintenance operation A ends. The processor 36 may perform the emphasis process A (for example, a process of changing the color of the guide 53 that is displayed).

In the case where the maintenance operation A ends, the processor 36 performs the assistance function B and consequently causes the guide B to be displayed (a step S14). In an example described herein, the processor 36 outputs the guide B so as to cause the display 26 to display a message 54 that represents the direction in which the collation image capturing device 12 is rotated about the Z-axis and the degree of rotation (that is, the rotation angle) at this time. The processor 36 may output the message 54 by using a voice. The processor 36 may cause the display 26 to display a figure (for example, an arrow) that represents the direction of rotation.

The user changes the rotation angle of the collation image capturing device 12 about the Z-axis in accordance with the message 54 (a step S15). This operation corresponds to the maintenance operation B. In the example illustrated in FIG. 12, the rotation angle about the Z-axis between the object 46 and the collation image capturing device 12 is maintained at the specific angle at the step S15. In this case, the processor 36 determines that the maintenance operation B ends. The processor 36 may perform the emphasis process B.

In the case where the maintenance operation B ends, the processor 36 performs the assistance function C. For example, the processor 36 causes the display 26 to display the coordinate axis figure 50 and the mark 52 illustrated in FIG. 11. The user performs the maintenance operation C as in the operation related to the step S07 illustrated in FIG. 11.

### Third Example

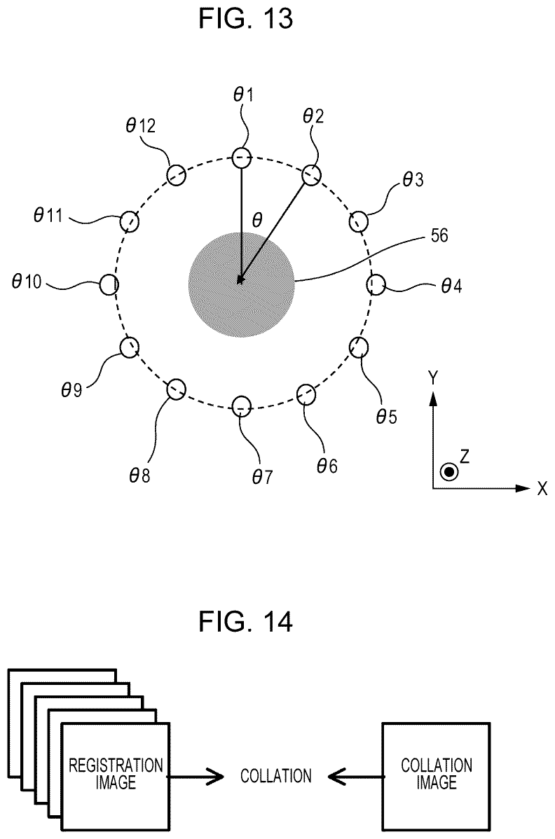

A third example will now be described with reference to FIG. 13 and FIG. 14. FIG. 13 illustrates an object 56 viewed in the Z-direction. FIG. 14 illustrates registration images and a collation image.

In the third example, the assistance function B is not performed, but the assistance functions A and C are performed. Accordingly, the maintenance operation B is not performed, but the maintenance operations A and C are performed.

A character string such as a logo is not displayed on the object 56 in the third example. In an example described herein, the object 56 has a circular shape.

In the case where the registration images of the object 56 are acquired, light is radiated to the object 56 in multiple different radiation directions, the image of the object 56 is captured, and consequently, the multiple registration images are acquired in different light radiation directions.

For example, an axis perpendicular to the surface of the object 56 is defined as the Z-axis, and the rotation angle about the Z-axis is defined as an angle θ. θ1 to θ12 illustrated in FIG. 13 represent the angle of the light source 16 about the Z-axis when the registration images are acquired. In an example illustrated in FIG. 13, the image of the object 56 is captured 12 times when the registration images of the object 56 are acquired, and 12 registration images are acquired in the different light radiation directions. Specifically, the angle θ1 is an angle at which the light source 16 is disposed when the image is captured for the first time, and the angle θ2 is an angle at which the light source 16 is disposed when the image is captured for the second time. The same is true for the angles θ3 to θ12. The 12 registration images are outputted to the collation device 14 and are stored in the memory 42 of the collation device 14. Consequently, the 12 registration images are registered in the registration image DB. The angles θ1 to θ12 are just examples. The number of times the image is captured when the registration images are acquired is not limited to 12 times. The number of times the image is captured may be determined depending on, for example, the shape, size, or the kind of the random pattern of the object 56.

In the third example, the guide A is outputted with the result that the assistance function A is performed, and the user performs the maintenance operation A in accordance with the guide A. For example, the guide 48a in the first example or the guide 53 in the second example is displayed as the guide A. In the case where the maintenance operation A ends, the guide C is outputted with the result that the assistance function C is performed, and the user performs the maintenance operation C in accordance with the guide C. For example, the coordinate axis figure 50 and the mark 52 in the first example are displayed as the guide C. The assistance function C may be performed before the assistance function A.

For example, in the case where the position at which the object 56 is displayed substantially matches the position at which the guide 48a is displayed, and the position at which the mark 52 is displayed substantially matches the position at which the intersection point 50C is displayed, all of the maintenance operations end. For example, in this state, the camera 24 acquires the collation image of the object 56.

The collation image is outputted from the collation image capturing device 12 to the collation device 14. The processor 44 of the collation device 14 collates the multiple registration images that are captured at various angles θ and the collation image.

FIG. 14 illustrates an example of the collation. In the example described above, the 12 registration images are acquired when the object 56 is registered, and accordingly, the processor 44 collates the 12 registration images and the collation image.

The processor 44 may identify the light radiation directions from the luminance distribution of the collation image or the spot of light detected in the collation image, may identify the registration image that is captured in the same radiation direction as the identified radiation direction among the multiple registration images, and may collate the identified registration image and the collation image.

### Collation Method

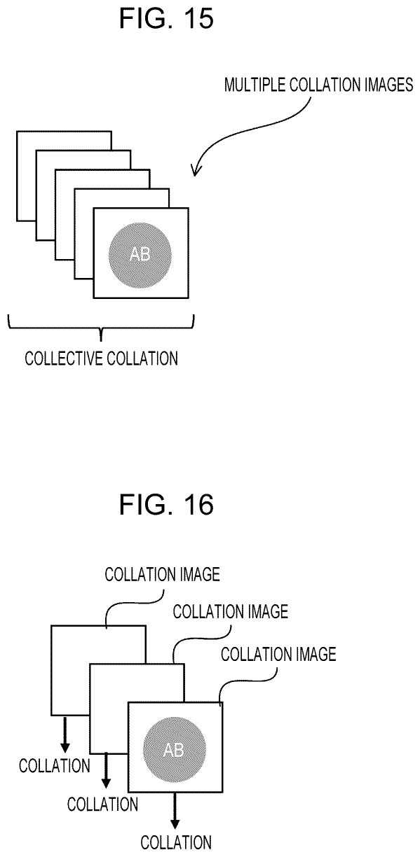

A specific example of a method of collating the registration images and collation images will now be described with reference to FIG. 15 and FIG. 16. FIG. 15 and FIG. 16 illustrate the collation images. FIG. 15 is a diagram for describing a first collation method. FIG. 16 is a diagram for describing a second collation method.

In the first collation method, the collation image capturing device 12 acquires the multiple collation images, and the multiple collation images and the registration images are subsequently collated. In the first example and the second example, for example, when the maintenance operations A, B, and C are performed, the camera 24 of the collation image capturing device 12 acquires the multiple collation images by capturing the image of the object at any time or at a regular interval. In the third example, when the maintenance operations A and C are performed, the multiple collation images are acquired at any time or at a regular interval. The acquired multiple collation images are stored in the memory 34 of the collation image capturing device 12. Capturing the image may be suspended in response to a user instruction. The acquired multiple collation images are collectively transmitted from the collation image capturing device 12 to the collation device 14. For example, in the case where all of the maintenance operations end (for example, in the case where the maintenance operations A, B, and C end in the first example and the second example, or in the case where the maintenance operations A and C end in the third example), or in the case where the user requests the transmission of the collation images, the processor 36 transmits the multiple collation images that are stored in the memory 34 to the collation device 14. The collation image capturing device 12 thus captures and stores the collation images and transmits the multiple collation images that are captured and stored to the collation device 14. The processor 44 of the collation device 14 collates the multiple collation images and the registration images and transmits the result of collation to the collation image capturing device 12. Consequently, the result of collation by using the multiple collation images that are captured and stored is outputted to the collation image capturing device 12. In this way, the collation by using the multiple collation images that are captured and stored may reduce the probability of erroneous determination. In this case, the processor 44 may transmit information that represents the collation images that match the registration images to the collation image capturing device 12 as the result of collation.

In the second collation method, the acquired collation image and the registration images are collated whenever the collation image capturing device 12 acquires the collation image. In the first example and the second example, for example, when the maintenance operations A, B, and C are performed, the camera 24 of the collation image capturing device 12 acquires the collation image by capturing the image of the object at any time or at a regular interval, and the processor 36 transmits the collation image to the collation device 14 whenever the collation image is acquired. In the third example, when the maintenance operations A and C are performed, the collation image is acquired and transmitted to the collation device 14 at any time or at a regular interval. Capturing the image may be suspended in response to a user instruction. Whenever the processor 44 of the collation device 14 receives the collation image that is transmitted from the collation image capturing device 12, the processor 44 collates the received collation image and the registration images, and the result of collation is transmitted to the collation image capturing device 12. Consequently, while the maintenance operations are performed, the result of collation is provided to the user, and a time required for the collation decreases.

In another collation method, in the case where the user requests the collation by using the collation image capturing device 12 when the maintenance operations are performed, the processor 36 may transmit one or multiple collation images that are acquired until the request is received to the collation device 14. At this time, the user may select the collation image to be collated. The processor 44 of the collation device 14 collates the one or multiple collation images that are transmitted from the collation image capturing device 12 and the registration images and transmits the result of collation to the collation image capturing device 12

In another collation method, in the case where the positional relationship between the object and the collation image capturing device 12 becomes the specific positional relationship, and the angles of the collation image capturing device 12 with respect to the object become the specific angles, the processor 36 may control the camera 24 and may cause the camera 24 to capture the image of the object. The processor 36 transmits the captured collation image to the collation device 14. The collation device 14 collates the collation image that is transmitted from the collation image capturing device 12 and the registration images and transmits the result of collation to the collation image capturing device 12. The collation image that is acquired by capturing the image of the object at the ideal capturing position and the ideal angles is collated. In this way, the precision of the collation may be improved unlike the case where a collation image that is acquired in different conditions is collated. That is, in this way, the collation image that improves the precision of the collation may be acquired.

The processor 36 of the collation image capturing device 12 may collate the registration images and the collation image. For example, when the collation image is acquired, the processor 36 acquires the registration images from the collation device 14 and collates the registration images and the collation image. The registration images may not be stored in the collation device 14 but may be stored in another device (for example, an image server), and the collation image capturing device 12 may acquire the registration images from the other device.

For example, the collation image capturing device 12 and the collation device 14 described above are provided by using hardware and software in corporation with each other. For example, the processor of each device reads and runs a program that is stored in the memory of the device, and consequently, the function of the device is fulfilled. The program is stored in the memory via a recording medium such as a CD or a DVD or via a communication path such as a network.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An information processing apparatus includes:
a processor configured to:
   perform a first function of assisting a user to perform a first operation of multiple operations on an image capturing device such that posture of the image capturing device that captures an image of an object with respect to the object is maintained in specific posture; and
perform a second function of assisting in performing a second operation of the multiple operations subsequent to the first operation in a case where the first operation ends.
   (((2)))

As for the information processing apparatus described in (((1))),
the processor is configured to:
   perform the second function in a case where a time during which the first function is performed becomes equal to or more than a threshold.
      (((3)))

As for the information processing apparatus described in (((1))) or (((2))),
the first function includes a function of outputting a first guide for assisting in performing the first operation by using a figure, a character string, or a sound, and
the second function includes a function of outputting a second guide for assisting in performing the second operation by using a figure, a character string, or a sound.
   (((4)))

As for the information processing apparatus described in (((3))),
the first function is a function of displaying the first guide on a display,
the second function is a function of displaying the second guide on the display, and
the processor is configured to: perform the second function and consequently causes the second guide to be displayed in the first guide.
   (((5)))

As for the information processing apparatus described in any one of (((1))) to (((4))),
the processor is configured to:
   perform an emphasis process in a case where at least one of the multiple operations ends to represent the case.
      (((6)))

As for the information processing apparatus described in any one of (((1))) to (((5))),
the processor is configured to:
   perform a first emphasis process in a case where the first operation ends to represent the case; and
   perform a second emphasis process that differs from the first emphasis process in a case where the second operation ends to represent the case.
      (((7)))

As for the information processing apparatus described in any one of (((1))) to (((6))),
the processor is configured to:
   perform an emphasis process that differs from the emphasis process that is performed when the at least one of the multiple operations ends in a case where the posture that is maintained by performing the first operation changes when the second operation is performed after the first operation ends.
      (((8)))

As for the information processing apparatus described in any one of (((1))) to (((7))),
the processor is configured to:
   provide a guide for prompting the user to perform the first operation in the case where the posture that is maintained by performing the first operation changes when the second operation is performed after the first operation ends.
      (((9)))

As for the information processing apparatus described in any one of (((1))) to (((8))),
the image capturing device captures and acquires a plurality of collation images when the user performs the first operation or the second operation, and
the plurality of collation images and a registration image for identifying the object are collated after the image capturing device acquires the plurality of collation images.
   (((10)))

As for the information processing apparatus described in any one of (((1))) to (((8))),
the image capturing device captures and acquires a collation image when the user performs the first operation or the second operation, and
the collation image and a registration image for identifying the object are collated whenever the image capturing device acquires the collation image.
   (((11)))

A program causing a computer to execute a process including:
performing a first function of assisting a user to perform a first operation of multiple operations on an image capturing device such that posture of the image capturing device that captures an image of an object with respect to the object is maintained in specific posture; and
performing a second function of assisting in performing a second operation of the multiple operations subsequent to the first operation in a case where the first operation ends.

What is claimed is:

1. An information processing apparatus comprising:
a processor configured to:
perform a first function of assisting a user to perform a first operation of multiple operations on an image capturing device such that posture of the image capturing device that captures an image of an object with respect to the object is maintained in specific posture; and
perform a second function of assisting in performing a second operation of the multiple operations subsequent to the first operation in a case where the first operation ends.

2. The information processing apparatus according to claim 1,
wherein the processor is configured to:
perform the second function in a case where a time during which the first function is performed becomes equal to or more than a threshold.

3. The information processing apparatus according to claim 1,
wherein the first function includes a function of outputting a first guide for assisting in performing the first operation by using a figure, a character string, or a sound, and
wherein the second function includes a function of outputting a second guide for assisting in performing the second operation by using a figure, a character string, or a sound.

4. The information processing apparatus according to claim 3,
wherein the first function is a function of displaying the first guide on a display,
wherein the second function is a function of displaying the second guide on the display, and
wherein the processor is configured to:
perform the second function and consequently causes the second guide to be displayed in the first guide.

5. The information processing apparatus according to claim 1,
wherein the processor is configured to:
perform an emphasis process in a case where at least one of the multiple operations ends to represent the case.

6. The information processing apparatus according to claim 5,
wherein the processor is configured to:
perform a first emphasis process in a case where the first operation ends to represent the case; and
perform a second emphasis process that differs from the first emphasis process in a case where the second operation ends to represent the case.

7. The information processing apparatus according to claim 5,
wherein the processor is configured to:
perform an emphasis process that differs from the emphasis process that is performed when the at least one of the multiple operations ends in a case where the posture that is maintained by performing the first operation changes when the second operation is performed after the first operation ends.

8. The information processing apparatus according to claim 7,
wherein the processor is configured to:
provide a guide for prompting the user to perform the first operation in the case where the posture that is maintained by performing the first operation changes when the second operation is performed after the first operation ends.

9. The information processing apparatus according to claim 1,
wherein the image capturing device captures and acquires a plurality of collation images when the user performs the first operation or the second operation, and
wherein the plurality of collation images and a registration image for identifying the object are collated after the image capturing device acquires the plurality of collation images.

10. The information processing apparatus according to claim 2,
wherein the image capturing device captures and acquires a plurality of collation images when the user performs the first operation or the second operation, and
wherein the plurality of collation images and a registration image for identifying the object are collated after the image capturing device acquires the plurality of collation images.

11. The information processing apparatus according to claim 3,
wherein the image capturing device captures and acquires a plurality of collation images when the user performs the first operation or the second operation, and
wherein the plurality of collation images and a registration image for identifying the object are collated after the image capturing device acquires the plurality of collation images.

12. The information processing apparatus according to claim 4,
wherein the image capturing device captures and acquires a plurality of collation images when the user performs the first operation or the second operation, and
wherein the plurality of collation images and a registration image for identifying the object are collated after the image capturing device acquires the plurality of collation images.

13. The information processing apparatus according to claim 5,
wherein the image capturing device captures and acquires a plurality of collation images when the user performs the first operation or the second operation, and
wherein the plurality of collation images and a registration image for identifying the object are collated after the image capturing device acquires the plurality of collation images.

14. The information processing apparatus according to claim 6,
wherein the image capturing device captures and acquires a plurality of collation images when the user performs the first operation or the second operation, and
wherein the plurality of collation images and a registration image for identifying the object are collated after the image capturing device acquires the plurality of collation images.

15. The information processing apparatus according to claim 7,
wherein the image capturing device captures and acquires a plurality of collation images when the user performs the first operation or the second operation, and
wherein the plurality of collation images and a registration image for identifying the object are collated after the image capturing device acquires the plurality of collation images.

16. The information processing apparatus according to claim 8,
wherein the image capturing device captures and acquires a plurality of collation images when the user performs the first operation or the second operation, and
wherein the plurality of collation images and a registration image for identifying the object are collated after the image capturing device acquires the plurality of collation images.

17. The information processing apparatus according to claim 1,
wherein the image capturing device captures and acquires a collation image when the user performs the first operation or the second operation, and
wherein the collation image and a registration image for identifying the object are collated whenever the image capturing device acquires the collation image.

18. The information processing apparatus according to claim 2,
wherein the image capturing device captures and acquires a collation image when the user performs the first operation or the second operation, and
wherein the collation image and a registration image for identifying the object are collated whenever the image capturing device acquires the collation image.

19. A non-transitory computer readable medium storing a program causing a computer to execute a process comprising:
performing a first function of assisting a user to perform a first operation of multiple operations on an image capturing device such that posture of the image capturing device that captures an image of an object with respect to the object is maintained in specific posture; and
performing a second function of assisting in performing a second operation of the multiple operations subsequent to the first operation in a case where the first operation ends.

20. An information processing method comprising:
performing a first function of assisting a user to perform a first operation of multiple operations on an image capturing device such that posture of the image capturing device that captures an image of an object with respect to the object is maintained in specific posture; and
performing a second function of assisting in performing a second operation of the multiple operations subsequent to the first operation in a case where the first operation ends.
